(19) United States
(12) Patent Application Publication
(10) Pub. No.: US 2017/0026553 A1
(43) Pub. Date: Jan. 26, 2017

(54) Displays With Camera Window Openings

(71) Applicant: Apple Inc., Cupertino, CA (US)

(72) Inventors: Szu-Hsien Lee, Cupertino, CA (US); Jin Yan, Santa Clara, CA (US); Kwang Soon Park, Cupertino, CA (US); Young Cheol Yang, Sunnyvale, CA (US)

(21) Appl. No.: 14/808,776

(22) Filed: Jul. 24, 2015

(51) Int. Cl. H04N 5/225; G02B 5/20; G02F 1/1339; G02F 1/1368; G02F 1/1335

(52) U.S. Cl. CPC H04N 5/2251; G02F 1/1368; G02F 1/133514; G02F 1/133516; G02F 1/1339; G02F 1/133512; G02B 5/20; G02F 2001/133302

(57) ABSTRACT

A display may include a color filter glass layer and a thin-film transistor glass layer that are attached with sealant. The thin-film transistor glass layer may have a recess in an inactive area of the display that accommodates a camera. The display layers may be provided with an opening that overlaps the recess. The recess may be a hole or a notch. The display may include circuitry and metal structures in the inactive area that are isolated from the recess with sealant. The sealant may have intersection points to isolate internal components from external contaminants and prevent reliability issues in the display. The display may be formed by cutting a motherglass layer into an individual display panel. The motherglass layer may include display layers attached with sealant. Cutting the mother glass layer may include cutting the sealant.

### BACKGROUND

This relates to electronic devices and, more particularly, to electronic devices with optical devices such as cameras.

Electronic devices such as portable computers and cellular telephones often have cameras. Cameras may be used to take still images and may be used to support video features such as video calls.

In a cellular telephone with a camera, the camera may be mounted under a portion of a cover glass layer in the display of the cellular telephone. Black ink may be printed under the cover glass to hide the camera from view. An opening may be formed in the black ink and the cover glass layer to form a window for the camera.

In a portable computer, a camera may be mounted along the upper edge of the display. In a typical arrangement, the display may be mounted within the housing of the portable computer using a bezel. An opening may be provided in the bezel to form a window for the camera or a camera may be located under an opening in a black ink border region.

Camera mounting arrangements such as these may not be satisfactory in device configurations where space is at a premium. For example, mounting arrangements in which a camera is attached to the lower surface of a display may consume more interior space in a device than is desired. Additionally, in arrangements where there is an opening in the black ink and the cover glass, external contaminants may enter the interior of the device. This may result in reliability issues such as corrosion of the interior components of the device.

It would therefore be desirable to be able to provide improved camera and display structures for electronic devices.

### SUMMARY

An electronic device may be provided with a display mounted in a housing. The display may include a color filter layer, a liquid crystal layer, and a thin-film transistor layer. Polarizers may be formed above and below the color filter layer and the thin-film transistor layer, respectively.

The color filter layer may form the outermost layer of the display. A camera window may be formed in the display to accommodate a camera. An opaque masking layer may be formed in an inactive border region along the edge of the display. The opaque masking layer and the color filter layer may have an opening that is aligned with the camera window to allow light to pass through the opaque masking layer and the color filter layer to the camera.

The camera window may be formed by creating a notch in the thin-film transistor layer that extends inwardly from the edge of the thin-film transistor layer. The camera window may also be formed by grinding a hole in the display using grinding equipment. The camera may be mounted in the recess or hole in the display and may be aligned with the opening in the opaque masking layer and the color filter layer.

The opening that is formed in the opaque masking layer and the color filter layer may allow external contaminants such as dust and moisture to enter the interior of the electronic device. These external contaminants may cause metal corrosion or other reliability issues within the display. To prevent the adverse effects of the external contaminants, the display may be provided with sealant.

Sealant may be used to attach the color filter layer to the thin-film transistor layer in the display. The sealant may surround the periphery of an active area of the display as well as the periphery of an inactive area of the display. The sealant may have one or more intersection points. The sealant may surround electrical components in the inactive area of the display.

A sealant application tool may be used to deposit the sealant on either the color filter layer or the thin-film transistor layer. The color filter layer and thin-film transistor layer may subsequently be attached with the sealant. After being attached, the color filter layer and thin-film transistor layer may be cut. Cutting the color filter layer and thin-film transistor layer may include cutting the sealant. After cutting the display layer to form a single display panel, a recess may be formed in an edge of the thin-film transistor layer. The sealant may be adjacent to the edge of the thin-film transistor layer such that the recess is completely surrounded by sealant. A camera may then be mounted within the notch.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with a display that has a camera window in accordance with an embodiment.

FIG. 2 is a perspective view of an illustrative electronic device such as a handheld electronic device with a display that has a camera window in accordance with an embodiment.

FIG. 3 is a perspective view of an illustrative electronic device such as a tablet computer with a display that has a camera window in accordance with an embodiment.

FIG. 4 is a perspective view of an illustrative electronic device such as a computer display with display structures having a camera window in accordance with an embodiment.

FIG. 5 is a cross-sectional side view of an illustrative display in accordance with an embodiment.

FIG. 6 is a cross-sectional side view of an illustrative display having an opening that accommodates a camera in accordance with an embodiment.

FIG. 7 is a cross-sectional side view of illustrative display layers having an opening that accommodates a camera in accordance with an embodiment.

FIG. 8 is a perspective view of an illustrative camera mounted to a flexible printed circuit cable in accordance with an embodiment.

FIG. 9 is a perspective view of illustrative display layers in a display panel showing how an opening may be formed by scribing a portion of the display panel with a computer-controlled scribing wheel in accordance with an embodiment.

FIG. 10 is a perspective view of illustrative display layers in a display panel showing how an opening may be formed by scribing a portion of the display panel with a computer-controlled laser in accordance with an embodiment.

FIG. 11 is a perspective view of an illustrative display panel and an adjacent rotating grinding bit for forming a window opening in accordance with an embodiment.

FIG. 12 is a perspective view of an illustrative display panel in which a portion of a thin-film transistor layer has been removed using wheel-based or laser-based scribing techniques in accordance with an embodiment.

FIG. 13 is a perspective view of the display panel of FIG. 11 following formation of a ground hole using the equipment of FIG. 11 in accordance with an embodiment.

FIG. 14 is a top view of an illustrative display where a notch is formed in an edge of the display in accordance with an embodiment.

FIG. 15 is a top view of an illustrative display where a hole is formed in a portion of the display in accordance with an embodiment.

FIG. 16 is a top view of an illustrative mother glass layer that may be cut to form display panels with holes in accordance with an embodiment.

FIG. 17 is a top view an illustrative mother glass layer that may be cut to form display panels with notches in accordance with an embodiment.

FIG. 18 is a top view of an illustrative display with a notch and sealant lines that have two intersection points to isolate portions of the display in accordance with an embodiment.

FIG. 19 is a top view of an illustrative display with a notch and sealant lines that have four intersection points to isolate portions of the display in accordance with an embodiment.

FIG. 20 is a top view of an illustrative display with a notch and sealant lines that have three intersection points to isolate portions of the display in accordance with an embodiment.

FIG. 21 is a top view of an illustrative display with a notch and sealant lines that extend to the edge of the display in accordance with an embodiment.

FIG. 22 is a top view of an illustrative display with a notch and sealant lines that merge to isolate portions of the display in accordance with an embodiment.

FIG. 23 is a top view of an illustrative display with a notch and sealant lines that merge to isolate portions of the display in accordance with an embodiment.

FIG. 24 is a top view of an illustrative display with a hole and sealant lines that have two intersection points to isolate portions of the display in accordance with an embodiment.

FIG. 25 is a top view of an illustrative display with a hole and sealant lines that have three intersection points to isolate portions of the display in accordance with an embodiment.

FIG. 26 is a top view of an illustrative display with a hole and sealant lines that have six intersection points to isolate portions of the display in accordance with an embodiment.

### DETAILED DESCRIPTION

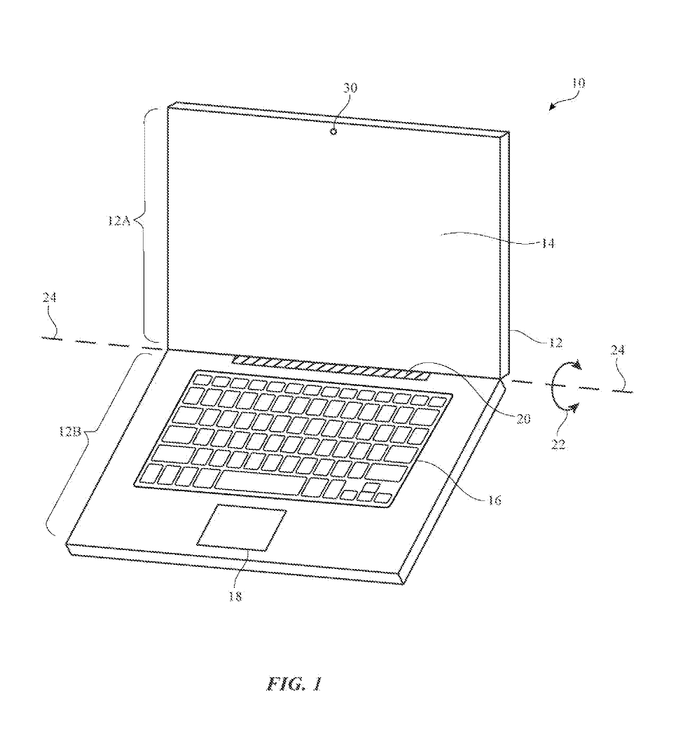

Electronic devices may include displays. The displays may be used to display images to a user. Cameras may be used to capture images. The cameras may be mounted in alignment with camera windows in the displays. Illustrative electronic devices that may be provided with displays having camera windows are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24. Camera window 30 may be formed along the upper edge of display 14 or elsewhere on display 14.

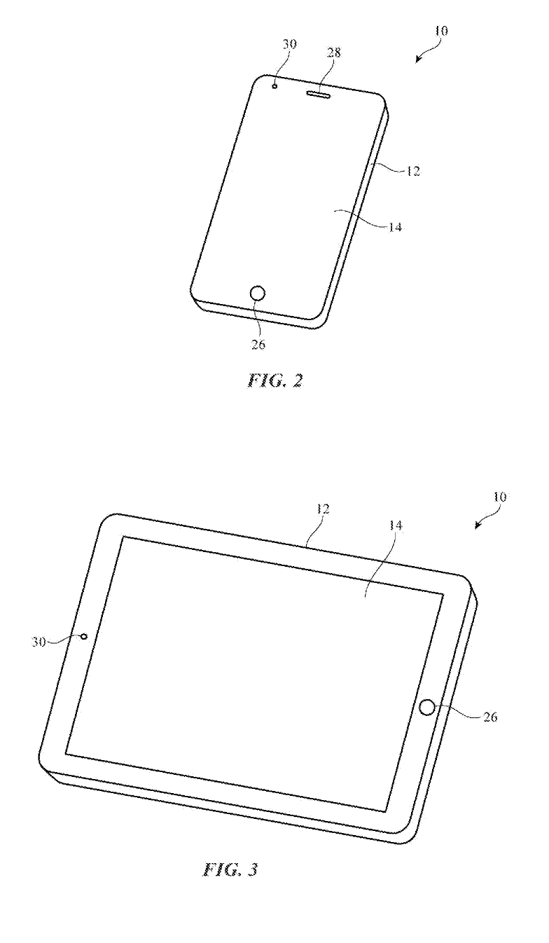

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Display 14 may be protected using a display cover layer such as a layer of transparent glass or clear plastic. Openings may be formed in the display cover layer. For example, an opening may be formed in the display cover layer to accommodate a button such as button 26. An opening may also be formed in the display cover layer to accommodate ports such as speaker port 28. Openings may be formed in housing 12 to form communications ports, holes for buttons, and other structures. Camera window 30 may be formed adjacent to speaker port 28 or elsewhere on display 14.

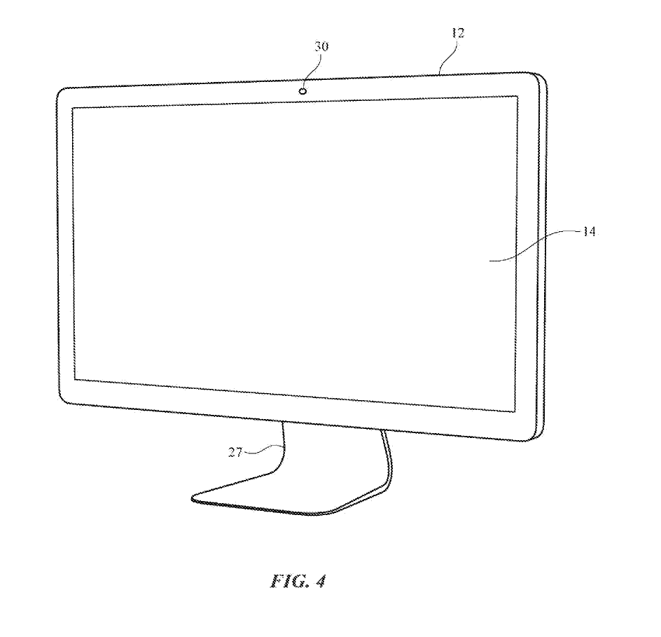

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an opening to accommodate button 26. Camera window 30 may be formed on an opposing edge of display 14 or may be formed elsewhere on display 14.

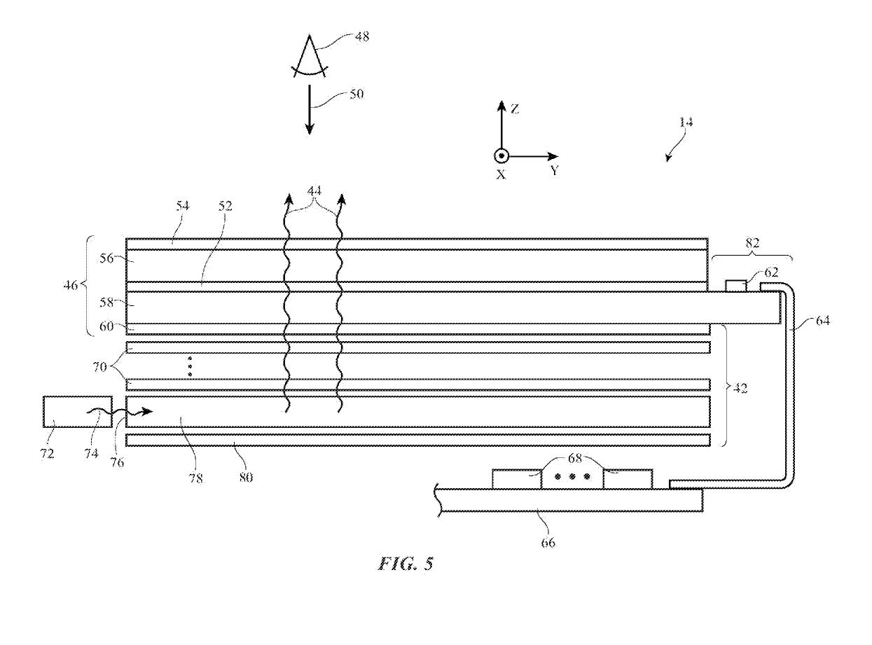

FIG. 4 shows an illustrative configuration for electronic device 10 in which device 10 is a computer display, a computer that has an integrated computer display, or a television. Display 14 is mounted on a front face of housing 12. With this type of arrangement, housing 12 for device 10 may be mounted on a wall or may have an optional structure such as support stand 27 to support device 10 on a flat surface such as a table top or desk. Camera window 30 may be formed along the upper edge of display 14 or elsewhere on display 14.

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may be a liquid crystal display, an organic light-emitting diode display, a plasma display, an electrophoretic display, an electrowetting display, a display using other types of display technology, or a display that includes display structures formed using more than one of these display technologies.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member. An advantage of forming display 14 without a cover layer is that this type of configuration may be thinner than configurations in which a display cover layer is present. Configurations for display 14 in which no display cover layer is present are sometimes described herein as an example.

Device 10 may include optical sensors such as light-based proximity sensors and ambient light sensors, status indicator lights, cameras, and other optical components. These components may be mounted under a window in display 14 such as window 30 (i.e., window 30 may form an optical device window). Configurations in which window 30 is a camera window and in which a camera is mounted in alignment with window 30 are sometimes described herein as an example.

A cross-sectional side view of an illustrative configuration for display 14 of device 10 (e.g., for display 14 of the devices of FIG. 1, FIG. 2, FIG. 3, FIG. 4 or other suitable electronic devices) is shown in FIG. 5. As shown in FIG. 5, display 14 may include backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a configuration in which display layers 46 are used in forming a liquid crystal display, display layers 46 may include a liquid crystal layer such a liquid crystal layer 52. Liquid crystal layer 52 may be interposed between display layers such as display layers 58 and 56. Layers 56 and 58 may be interposed between lower polarizer layer 60 and upper polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits such as components 68 on printed circuit 66 of FIG. 5) may be used to generate information to be displayed on display 14 (e.g., display data). The information to be displayed may be conveyed from circuitry 68 to display driver integrated circuit 62 using a signal path such as a signal path formed from conductive metal traces in flexible printed circuit 64 (as an example).

Display driver integrated circuit 62 may be mounted on thin-film-transistor layer driver ledge 82 or elsewhere in device 10. A flexible printed circuit cable such as flexible printed circuit 64 may be used in routing signals between printed circuit 66 and thin-film-transistor layer 58. If desired, display driver integrated circuit 62 may be mounted on printed circuit 66 or flexible printed circuit 64. Printed circuit 66 may be formed from a rigid printed circuit board (e.g., a layer of fiberglass-filled epoxy) or a flexible printed circuit (e.g., a flexible sheet of polyimide or other flexible polymer layer).

Backlight structures 42 may include a light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed in dimensions X and Y throughout light guide plate 78 due to the principal of total internal reflection. Light guide plate 78 may include light-scattering features such as pits or bumps. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 5, optical films 70 and reflector 80 may have a matching rectangular footprint.

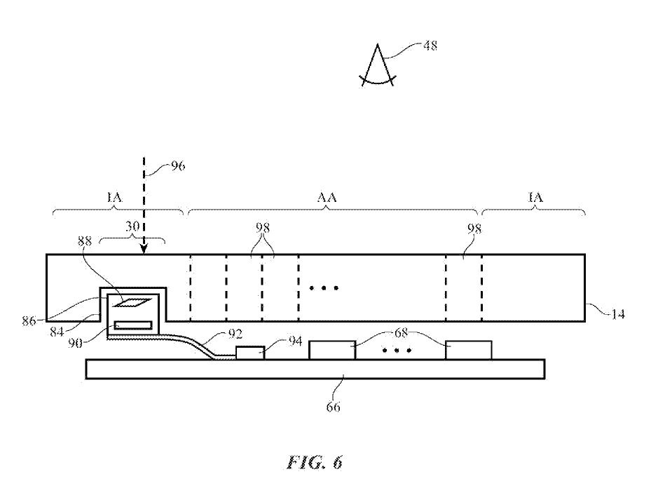

As shown in FIG. 6, display 14 may be characterized by an active area such as active area AA. Active area AA may include an array of display pixels 98. Display pixels 98 may be used in displaying images to viewer 48 during operation of device 10. An inactive border region such as inactive area IA may surround the periphery of active area AA. For example, active area AA may have a rectangular shape surrounded by four peripheral edges and inactive region 1A may have the shape of a rectangular ring that runs along each of the four peripheral edges of active area AA and thereby surrounds active area AA.

Camera window 30 may be formed by creating an opening in one or more of the layers of display 14 such as opening 84. Opening 84 may be formed along the edge of display 14 (i.e., opening 84 may be a notch in the edge of display 14 that extends inwardly from an edge of the display and that passes partway through display 14) or may a hole that passes partway through display 14 (as shown in the FIG. 6 example).

An optical component such as camera 86 may be mounted within window opening 84. Camera 86, which may sometimes be referred to as a camera module, may be formed from a plastic housing or other housing structure that encloses components such as lens structures 88 and digital image sensor 90. During operation, light 96 may pass through camera window 30. Lens structures 88 may include one or more lenses formed from glass or plastic. Lens structures 88 may focus light 96 onto digital image sensor 90. Digital image sensor 90 may be coupled to components 68 on a substrate such as substrate 66 using a communications path such as communications path 92. Communications path 92 may be a flexible printed circuit (e.g., a layer of polyimide or other flexible polymer substrate with metal traces that form a signal bus for a flexible printed circuit cable) or may be formed from other structures. A connector such as connector 94 (e.g., a board-to-board connector) may be used in coupling flexible printed circuit cable 92 to substrate 66. Circuitry 68 may include processors for processing image data from camera 86 and other circuitry.

The presence of an opening such as opening 84 that passes partly through the layers of display 14 may help accommodate camera 86. For example, some or all of camera 86 may protrude into opening 84 as shown in FIG. 6, which reduces or eliminates the volume consumed by camera outside of the layers of display 14. By mounting components in device 10 efficiently, the size of device 10 can be minimized and/or space may be made available within device 10 for other components.

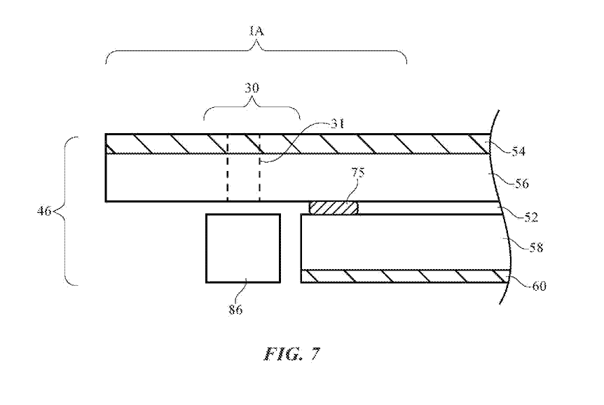

FIG. 7 is a cross-sectional side view of illustrative display layers having an opening that accommodates a camera. In this illustrative example, opening 84 may be formed in lower polarizer layer 60, layer 58, and liquid crystal layer 52, leaving layer 56 and upper polarizer layer 54 to extend over camera 86. Display layers 46 may also include an opaque masking layer to prevent internal components from being viewed by a user. The opaque masking layer may be, for example, a layer of black ink on the bottom surface of layer 56. The opaque masking layer may be positioned at another position within the display layers if desired. Camera 86 may protrude into space formerly occupied by layer 58 and lower polarizer layer 60.

In certain embodiments, opening 31 may be included in display layers 46. Opening 31 may extend through upper polarizing layer 54, layer 56, and any opaque masking layer that is present. In embodiments where recess 84 only passes through a portion of layer 58, opening 31 may extend through the remaining portion of layer 58 as well. Opening 31 may extend completely through display layers 46 to the exterior of the electronic device. Consequently, opening 31 may allow external contaminants to enter the electronic device, in order to prevent external contaminants from adversely affecting performance of the electronic device, sealant 75 may be included.

Sealant 75 may be used to laterally confine the liquid crystal layer. Sealant 75 may be positioned between layers 56 and 58. The presence of sealant 75 may also prevent external contaminants such as moisture or dust from entering the active display area and adversely affecting the active area of the display and any accompanying circuitry.

Sealant 75 may be any desired material. In certain embodiments, sealant 75 may be an epoxy based sealant. Sealant 75 may be an epoxy base sealant with optical fibers. In various embodiments, sealant 75 may be formed from a pressure sensitive adhesive, a liquid adhesive, a moisture curable adhesive, a thermally curable adhesive, a light curable adhesive, or any other desired type of adhesive.

FIG. 7 shows an illustrative camera window 30 that is formed by a notch in an edge of display 14 that extends inwardly from the edge of the display and passes partway through the display. However, this example is purely illustrative. If desired, camera window 30 may be formed from a hole that passes partway through display 14 (as shown in the FIG. 6 example). In these embodiments, layer 58 and the lower polarizer layer 60 may completely surround camera 86, as opposed to the example of FIG. 7 where layer 58 and the lower polarizer layer 60 only partially surround camera 86.

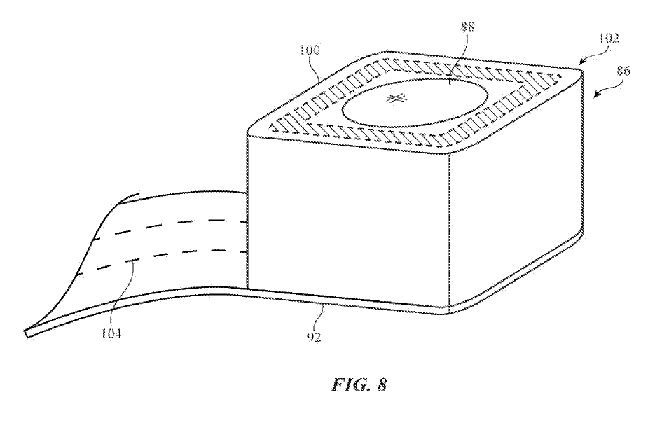

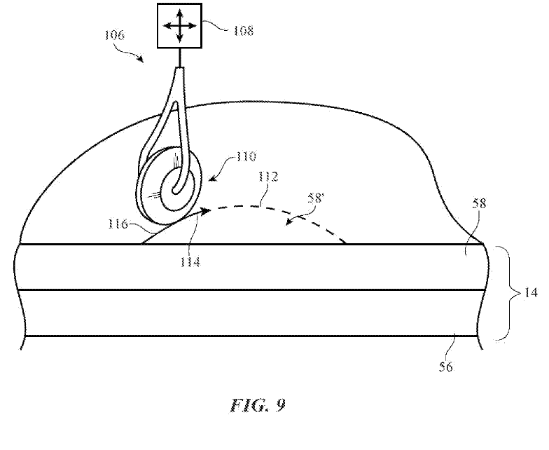

FIG. 8 is a perspective view of camera 86 showing how the housing for camera 86 may have a rectangular box shape with rounded corners 102 (as an example). Other shapes may be used for the camera housing if desired (e.g., cylindrical shapes with circular portions that fit within corresponding circular holes 84, shapes with right-angle corners, etc.). Camera 86 may be soldered or otherwise mounted on flexible printed circuit 92. Flexible printed circuit 92 may include metal traces such as traces 104. Traces 104 may be used in conveying power and data signals between camera 86 and circuitry 68 on substrate 66. A ring of adhesive such as adhesive 100 may surround lens structures 88 on the upper surface of camera 86. Adhesive 100 may be used in attaching camera 86 within recess 84 in display 14. Screws and other fasteners, solder, welds, clips, mounting brackets, and other structures may also be used in mounting camera 86 if desired. Lens 88 of camera 86 may be aligned with opening 31.

FIG. 9 is a perspective view of layers in display 14 during formation of a display camera window opening using a scribing tool. As shown in FIG. 9, the display panel for display 14 may include scribing equipment such as equipment 106. Equipment 106 may include a computer-controlled positioner such as positioner 108 that controls the position of scribing wheel 110. Scribing wheel 110 may be carbide glass cutting wheel, a diamond scribing wheel, or other scribing wheel. Using positioner 108, wheel 110 may be moved in direction 114 along path 112, thereby creating scribe line 116. The shape of scribe line 116 defines the shape of the camera window opening being formed.

After scribe line 116 has been formed, portion 58′ of layer 58 may be removed to form opening 84 by breaking portion 58′ away from the remainder of layer 58 along scribe line 116. In the example of FIG. 9, the shape of the scribe line is curved and the resulting shape of removable portion 58′ is semicircular (i.e., the process of scribing and removing portion 58′ from thin-film-transistor layer 58 forms a semicircular camera window notch 84 for camera window 30). Other scribe line shapes and resulting camera window opening shapes may be formed if desired (e.g., shapes with straight edges, shapes with straight edges with curved corners, shapes with curved edges, shapes with a combination of curved and straight edges, etc.).

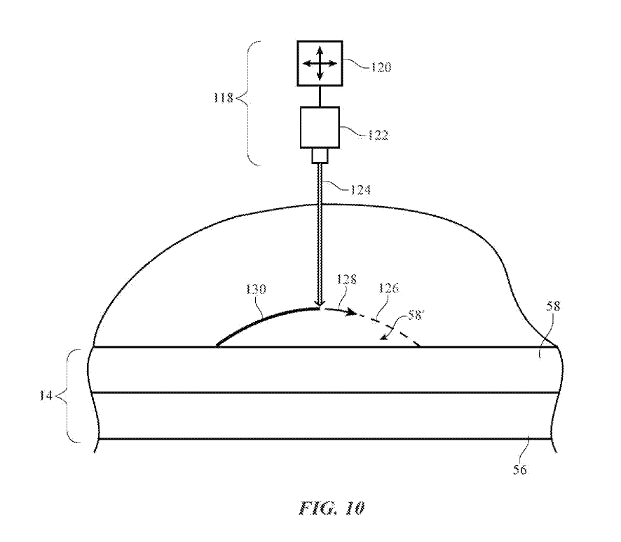

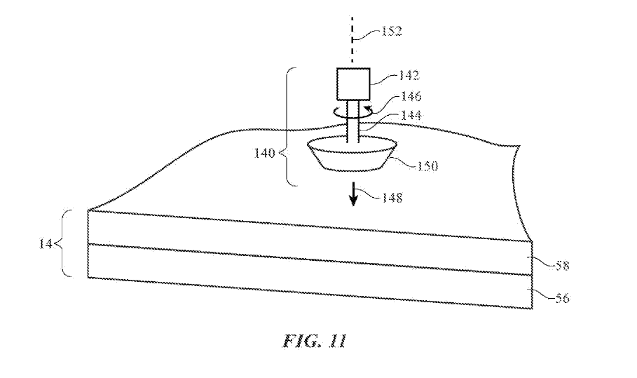

If desired, laser-based scribing equipment may be used in removing portion 58′ of thin-film transistor layer 58 in display 14. As shown in FIG. 10, laser-based scribing equipment 118 may include computer-controlled positioner 120. Computer-controlled positioner 120 may control the position of laser 122. During operation, laser 122 produces laser beam 124. Positioner 120 moves laser beam 124 in direction 128 along path 126. As shown in FIG. 10, this creates scribe line 130 around portion 58′ of thin-film transistor layer 58. As with the wheel-based scribing technique of FIG. 9, portion 58′ of layer 58 may be removed to form opening 84 by breaking portion 58′ away from the remainder of layer 58 along scribe line 130 following completion of scribe line 130 by laser-based scribing equipment 118. The shape of scribe line 130 and the associated shape of the resulting notch for the camera window opening formed by removing portion 58′ may be semicircular, may have straight edges, may have curved edges, may have a combination of straight and curved edges, etc.

If desired, camera window opening 84 may have the shape of a hole in one or more of the layers of display 14. As shown in FIG. 11, grinding tool 140 may include motor system 142. Motor system 142 rotates shaft 144 and grinding bit 150 in direction 146 about rotational axis 152. When it is desired to grind a hole in layer 58, motor system 142 may move rotating grinding bit 150 in direction 148 towards layer 58.

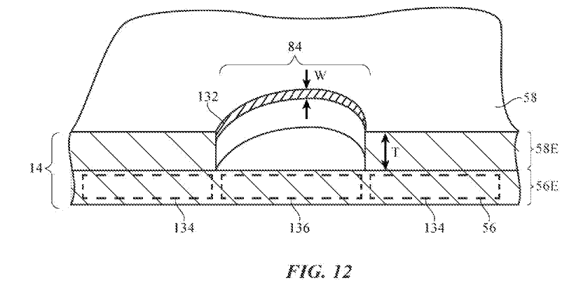

Following scribing of thin-film transistor layer 58 using wheel based scribing equipment 106 of FIG. 9, using laser-based scribing equipment 118, or using other scribing equipment, a camera window opening such as camera window notch 84 of FIG. 12 may be created in thin-film transistor layer 58. Scribing processes tend to produce minor surface damage along the scribe lines that are formed by the scribing equipment. For example, the process of rolling wheel 110 along the surface of layer 58 and the process of exposing the surface of layer 58 to laser light 124 along scribe line 130 tend to produce shallow surface damage such as surface damage 132 of FIG. 11 (i.e., a scribe-damaged surface region such as a wheel-scribed surface region or a laser-scribed surface region). When viewed from the side as shown in FIG. 11, surface damage 132 will penetrate into layer 58 only a relatively shallow distance W relative to the thickness T of layer 58.

The edges of layers 58 and 56 may be polished prior to removal of portion 58′ of layer 58. Polishing equipment such as a grinding tool with a rotating grinding head the travels around the peripheral edge of display 14 may be used to polish the edges. With this type of arrangement, layers 58 and 56 are attached during the polishing process, so the polishing head will polish thin-film transistor layer peripheral edge 58E in alignment with color filter layer peripheral edge 56E.

The presence of portion 58′ during polishing may help ensure that the polishing process proceeds evenly across the portion of edge 56E (i.e., portion 136 of color filter layer edge 56E adjacent to portion 58′ will be polished identically to adjacent portions 134 of color filter layer edge 56E). In the absence of portion 58′ during polishing, there is a potential for portion 136 of edge 56E to exhibit more chips or other imperfections than adjacent regions 134 (i.e., regions 136 and 134 would not have identically polished surfaces, because region 136 would be more damaged than regions 134). When portion 58′ is present during polishing, however, color filter layer edge region 134 and 146 will have matched (identically polished) surfaces, even though region 136 is adjacent to notch 84 and region 134 is not adjacent to notch 84 in the finished display.

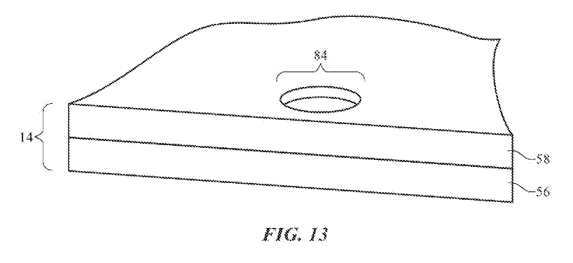

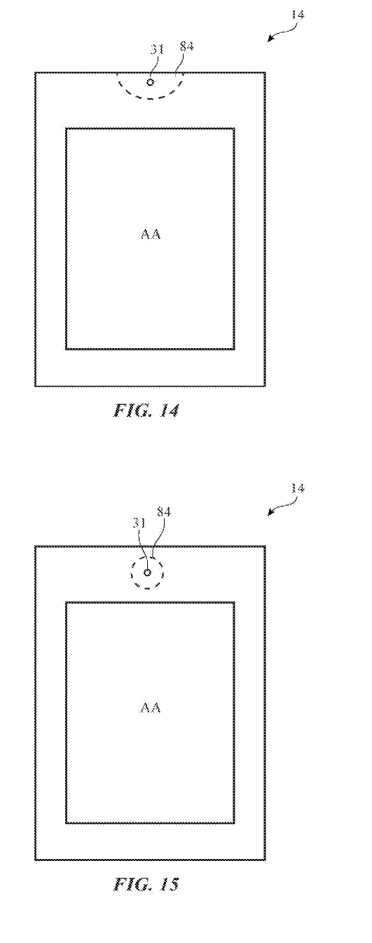

Following grinding of hole 84 to a desired depth into display 14 using, for example, the grinding tool of FIG. 11, hole 84 may appear as shown in FIG. 13 (i.e., hole 84 may form a recess in display 14 to accommodate camera 86). During subsequent assembly operations, camera 86 may be mounted within opening 84 (e.g., using adhesive 100 or other attachment mechanism).

FIGS. 14 and 15 show illustrative arrangements for recess 84 in display 14. As shown in FIG. 14, recess 84 may be a notch formed in an edge of display 14. Recess 84 may be formed on a top edge of display 14 above the active area of the display. Alternatively, recess 84 may be formed on a left, right, or bottom edge of the display. The notch may be formed in the corner of the display. The notch may be semi-circle shaped (e.g., FIG. 14). However, this example is merely illustrative and the notch may have any desired shape. The notch may be centered with respect to the edges of the display or may be offset from the center. In general, the notch may have any desired size or shape. FIG. 15 shows display 14 in embodiments where recess 84 is a hole. The hole may have any desired size. The example of the hole as a circle in FIG. 15 is merely illustrative, and the hole may have any desired shape (e.g., triangular, square, rectangular, etc.). In both embodiments where recess 84 is a notch (e.g., FIG. 14) and where recess 84 is a hole (e.g., FIG. 15), recess 84 may overlap opening 31.

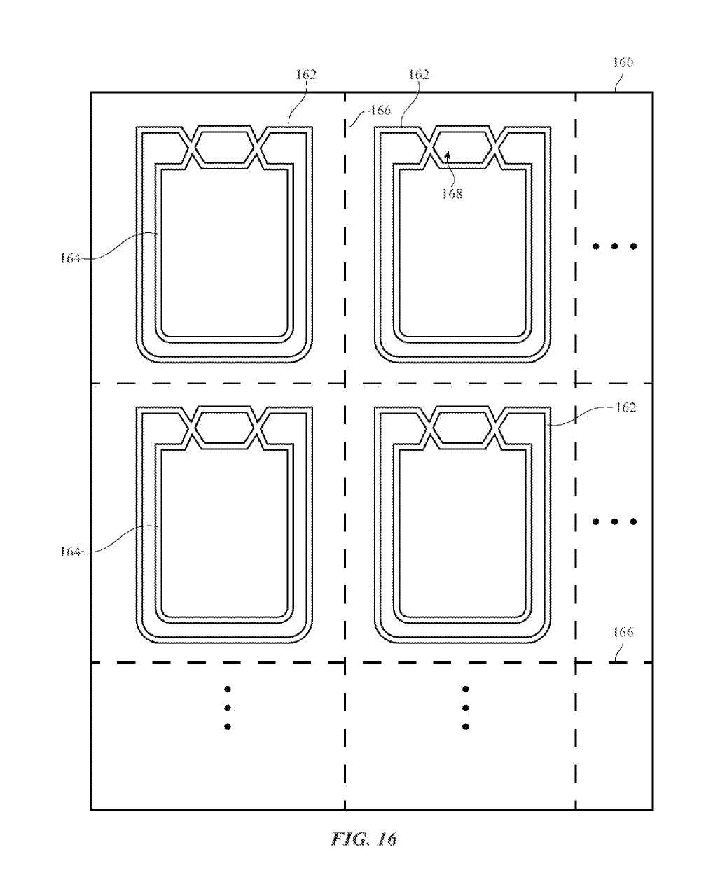

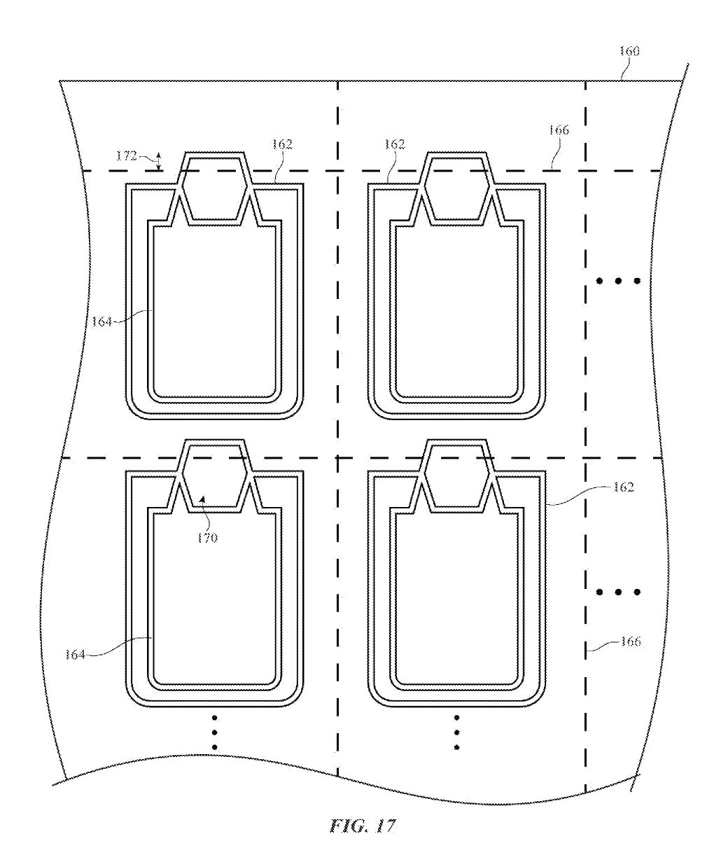

FIG. 16 shows an illustrative mother glass layer 160. Mother glass layer 160 may include a color filter mother glass layer and a thin-film transistor mother glass layer. The color filter mother glass layer and the thin-film transistor mother glass layer may be attached to each other using sealant lines 162 and 164. Sealant lines 162 and 164 may be formed from sealant such as sealant 75. After the color filter glass layer is attached to the thin-film transistor glass layer, mother glass layer 160 may be divided into individual display panels. Scribing equipment such as equipment 106 or laser-based scribing equipment such as laser-based scribing equipment 118 may be used to cut mother glass 160 along path 166.

Cutting along path 166 may form a number of individual display panels. Each display panel may have first and second sealant lines that attach the color filter glass 56 to the thin-film transistor mother glass layer 58. A liquid crystal layer 52 may be encapsulated between each color filter glass layer 56 and thin-film transistor mother glass layer 58. After forming individual display panels, recess 84 may be formed in each display panel. Recess 84 may pass partially through layer 58, may pass completely through layer 58 without penetrating layer 56, or may pass through layer 58 and part of layer 56. In embodiments where recess 84 is a hole (e.g., FIG. 15), recess 84 may be formed in area 168 in between sealant lines 162 and 164. This arrangement ensures that any contaminants that penetrate opening 31 will be constrained by sealant lines 162 and 164.

FIG. 17 also shows an illustrative mother glass layer 160 for forming individual display panels. As discussed in connection with FIG. 16, mother glass layer 160 may include a color filter mother glass layer and a thin-film transistor mother glass layer that are attached to each other using sealant lines 162 and 164. In this illustrative embodiment, path 166 for cutting mother glass 160 may pass through sealant line 164. After cutting along path 166 to form individual display panels, recess 84 may be formed in area 170. In certain embodiments, recess 84 may be a notch. Cutting sealant line 164 while forming display panels may be particularly advantageous in embodiments where recess 84 is a notch, as the remaining sealant will surround notch 84 up to the edge of layer 56. However, high stress may be induced while cutting sealant line 164. The resulting glass edge may not be as smooth due to the excess stress. Reducing the distance 172 that sealant 164 extends past cutting path 166 may reduce the amount of stress induced by cutting sealant line 164. Mother glass layer 160 in FIGS. 16 and 17 may be cut using cutting equipment such as scribing equipment 106 in FIG. 9 or laser-based cutting equipment 118 in FIG. 10. Other equipment and methods may be used to cut mother glass layer 160 if desired.

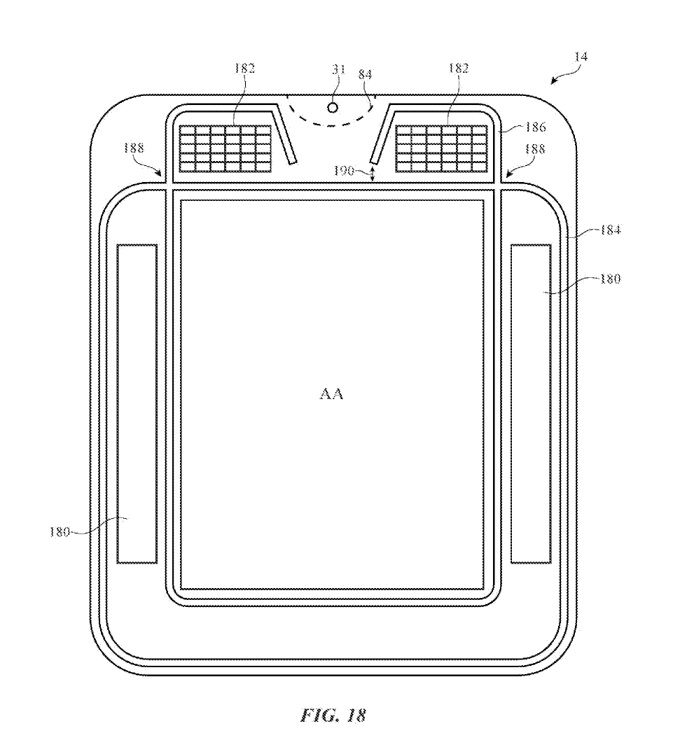

FIG. 18 is a top view of an illustrative display with glass layers attached by sealant. As shown, the active area of the display may be formed in a central portion of the display. The active area may be surrounded by circuitry 180. Circuitry 180 may include, for example, demultiplexing circuitry or the gate-integrated panel (GIP). Demultiplexing circuitry may be used to drive data lines of the pixel structures in the active area (AA). The gate-integrated panel may be used for driving gate lines of the pixel structures in the AA. The circuitry may be positioned on two sides of the AA (e.g., FIG. 18). However, this example is purely illustrative. Circuitry may instead be positioned on only one side of the AA or on three or four sides of the AA. Display 14 may also include metal structures 182. Metal structures 182 may be areas of metal mesh used for shielding in display 14. In FIG. 18, metal structures 182 are depicted as being formed on a top edge of the inactive area of the display, with metal structures on either side of recess 84. The example of FIG. 18 is purely illustrative, and metal structures 182 may be included on one, two, three, or four sides of the inactive area of the display.

Both metal structures 182 and circuitry 180 may be sensitive to the presence of external contaminants. In certain situations, external contaminants may enter the electronic device through opening 31. For example, display 14 may be exposed to moisture while in environments with high humidity. Alternatively, if the electronic device is exposed to fluids (e.g., during cleaning), the fluids may be able to enter the electronic device via opening 31. Exposure to moisture may cause corrosion in metal structures 182 and circuitry 180.

In order to prevent the internal components of display 14 from being exposed to external contaminants, display 14 may be provide with first sealant line 184 and second sealant line 186. Including multiple sealant lines may ensure that color filter glass 56 is attached firmly to thin film transistor glass 58, which will increase the strength and durability of the display. Multiple sealant lines also enables the recessed area 84 and opening 31 to be sealed from the interior components of display 14.

FIG. 18 shows one illustrative arrangement of sealant lines 184 and 186 in which sealant lines 184 and 186 have two intersection points. As shown, sealant lines 184 and 186 may surround the active area of the display. In FIG. 18, sealant line 184 is adjacent to one side of the periphery of the active area of the display and three sides of the periphery of the inactive area of the display, while sealant line 186 is adjacent to three sides of the periphery of the active area of the display and one side of the periphery of the inactive area of the display. This example is purely illustrative.

Sealant lines 184 and 186 may intersect at two points 188. Intersection points 188 may isolate circuitry 180 from contaminants that enter display 14 through opening 31. Sealant line 186 may partially surround metal structures 182. There may be a gap 190 between an end portion of sealant line 186 and sealant line 184. The gap may result in metal structures 182 being exposed to external contaminants. However, additional intersection points may cause the separation between layers 56 and 58 to be greater at the intersection points. Variation in separation between layers 56 and 58 may adversely affect performance of the display.

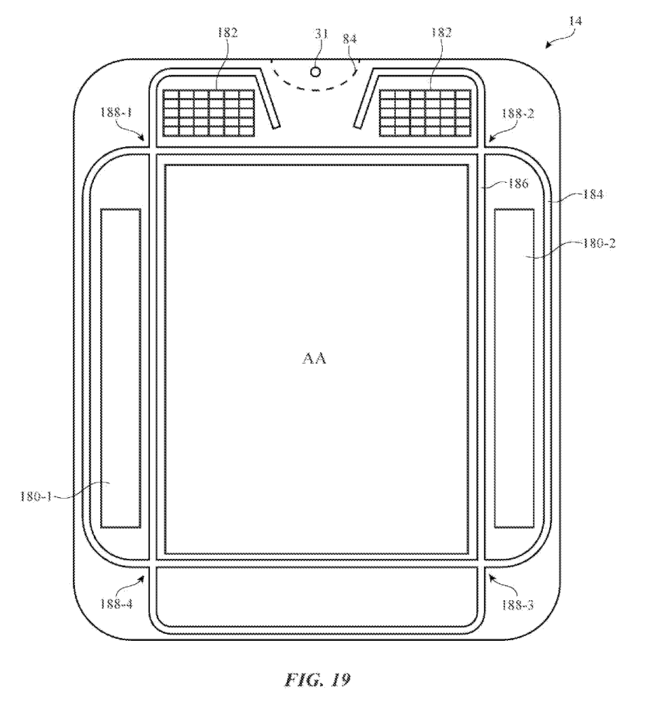

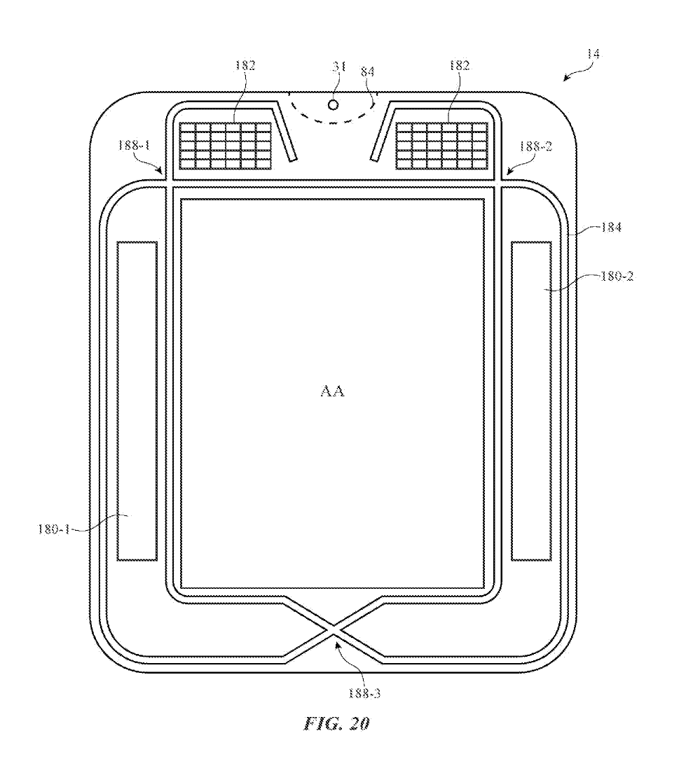

FIG. 19 shows an illustrative arrangement of sealant lines 184 and 186 in which sealant lines 184 and 186 have four intersection points. The additional intersection points may ensure that circuitry 180 is less likely to be exposed to external contaminants. Due to the additional intersection points, circuitry areas 180-1 and 180-2 are both completely surrounded by sealant. If a portion of the sealant lines surrounding circuitry 180-1 failed (e.g., allowed external contaminants to enter the area), only circuitry 180-1 would be affected. A second sealant failure would be necessary to expose circuitry 180-2 to external contaminants.

As shown in FIG. 19, both sealant lines 184 and 186 may be adjacent to two sides of the periphery of the active area and two sides of the periphery of the inactive area. Sealant line 184 is adjacent to the top and bottom sides of the periphery of the active area and the left and right sides of the periphery of the inactive area. Sealant line 186 is adjacent to the left and right sides of the periphery of the active area and the top and bottom sides of the periphery of the inactive area. This example is purely illustrative, and other arrangements of sealant lines 184 and 186 may be used if desired.

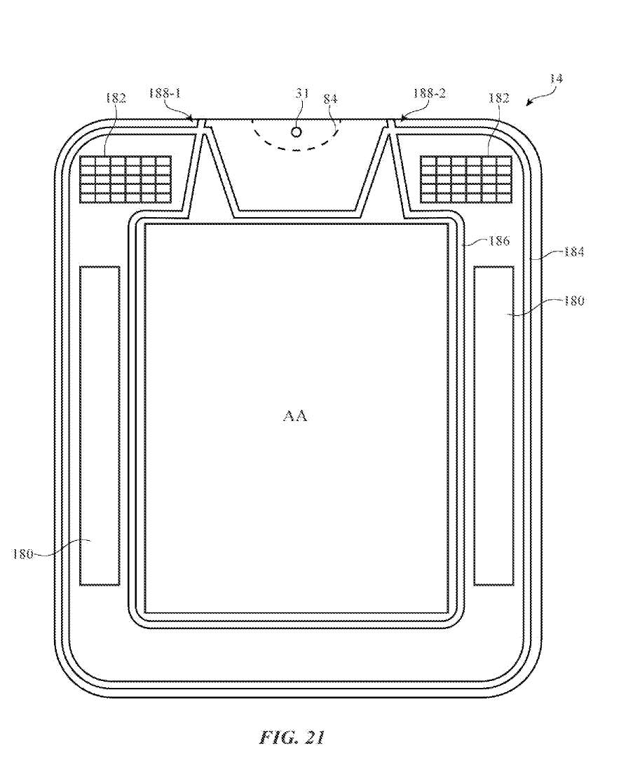

FIG. 20 shows an illustrative arrangement of sealant with three intersection points. The type of arrangement shown in FIG. 20 may have the advantage of circuitry 180-1 and circuitry 180-2 being isolated from each other by sealant line 184. If, for example, external contaminants were to penetrate sealant 184 and enter the area surrounding circuitry 180-1, intersection point 188-3 would still prevent the external contaminants from entering the area surrounding circuitry 180-2. Sealant 184 in FIG. 20 may deposited as a continuous line of sealant. Using a single sealant line instead of multiple sealant lines may reduce the complexity of manufacturing the electronic device.

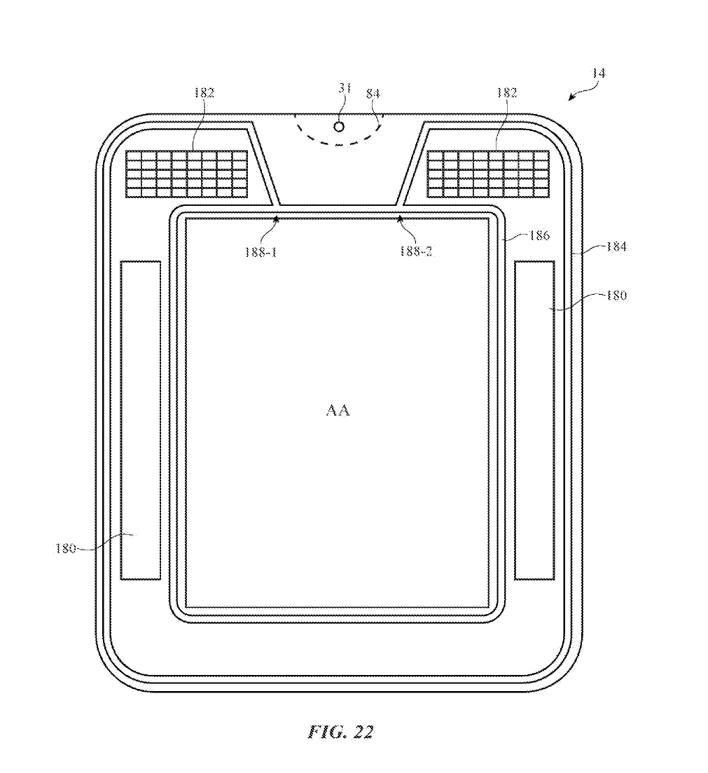

FIG. 21 shows an illustrative arrangement of sealant lines 184 and 186 in which sealant lines 184 and 186 have two intersection points. However, instead of a gap allowing external contaminants to possibly reach metal structures 182 (e.g., FIG. 18), points 188-1 and 188-2 may be positioned such that both metal structures 182 and circuitry 180 are completely surrounded by sealant. Sealant line 186 may extend to the edge of layers 56 and 58. The arrangement of FIG. 21 may result from cutting a mother glass into individual display panels by cutting through a sealant line. With this arrangement, sealant line 186 surrounds notch 84, meaning that external contaminants will be constrained to a smaller area of the display.

FIG. 22 shows an illustrative arrangement of sealant lines 184 and 186 in which sealant lines 184 and 186 have two intersection points and there is a greater area for metal structures 182. Intersection points 188-1 and 188-2 may isolate metal structures 182 and circuitry 180 from external contaminants. Additionally, with this arrangement there is a greater area for metal structures 182. The reduced area of metal structures 182 in previous embodiments (e.g., FIGS. 18-21) may result in reduced shielding of the display. The increased area of metal structures 182 in FIG. 22 may lead to improved display performance.

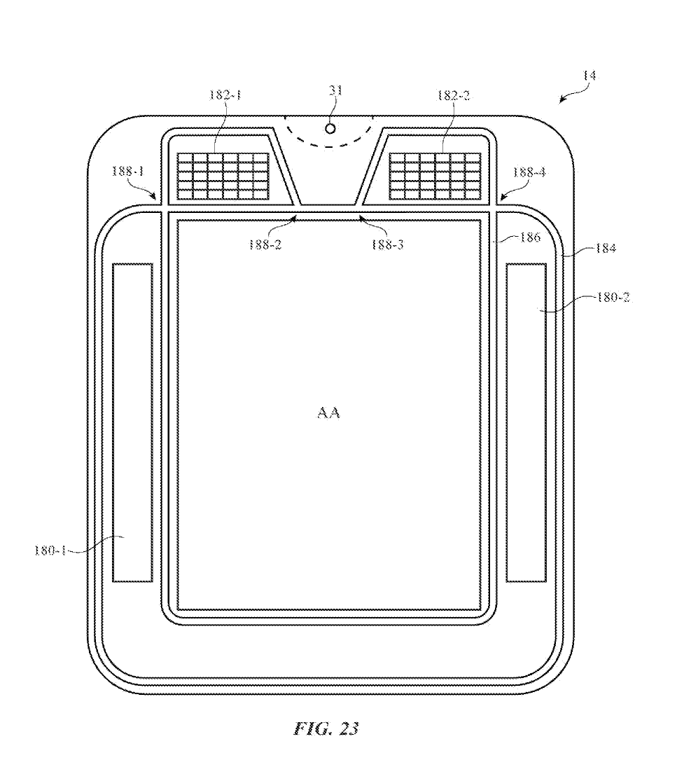

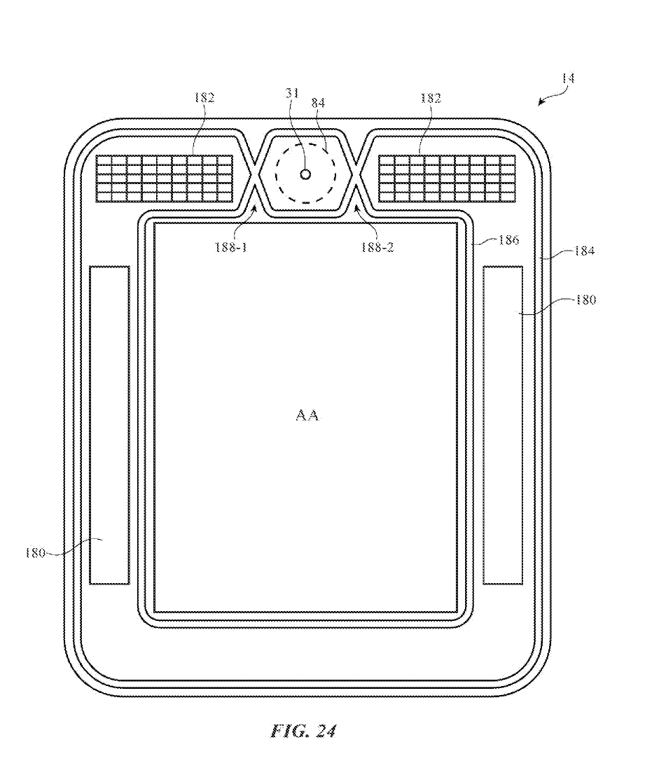

FIG. 23 shows an illustrative arrangement of sealant lines 184 and 186 in which sealant lines 184 and 186 have two intersection points. Additionally, sealant lines 184 and 186 may isolate metal structures 182 from circuitry 180. For example, if a portion of sealant line 186 failed and external contaminants entered the area containing metal structure 182-1, the intersection point 188-1 would prevent circuitry 180-1 from being exposed to the external contaminants. Additional crossover points may be added if desired. For example, sealant lines 184 and 186 of FIG. 23 may have additional cross over points such as 188-3 and 188-4 in FIG. 19 to isolate circuitry 180-1 from circuitry 180-2. In addition, sealant lines 184 and 186 may have an additional cross over point such as point 188-3 in FIG. 20.

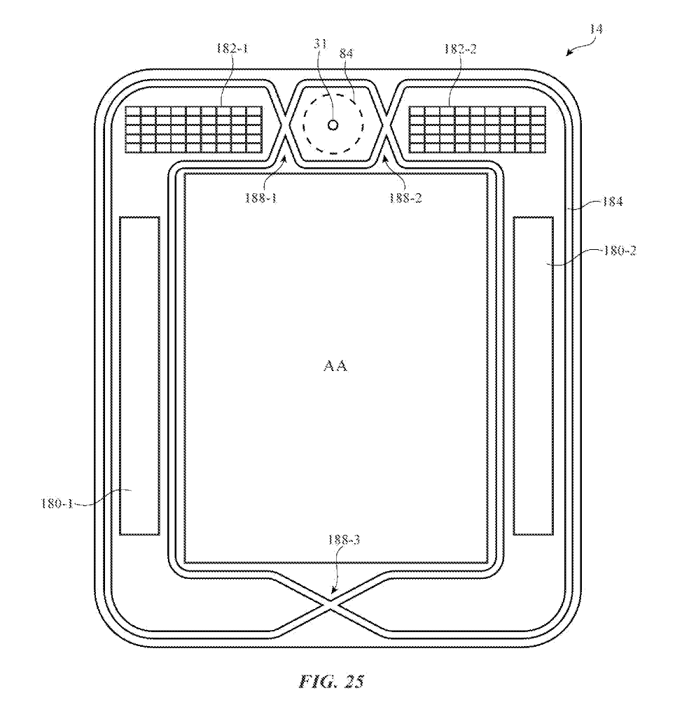

FIGS. 18-23 show illustrative displays where recess 84 is a notch. However, as shown in FIG. 24, recess 84 may also be a hole. In embodiments where recess 84 is a hole, sealant lines may surround recess 84 on all sides. As shown, sealant lines 184 and 186 may surround recess 84. Sealant lines 184 and 186 may have intersection points such as intersection points 188-1 and 188-2. Intersection points 188-1 and 188-2 may prevent external contaminants from reaching metal structures 182 and circuitry 180.

FIG. 25 shows an illustrative arrangement of sealant 184 in which sealant 184 has three intersection points. Similar to FIG. 24, sealant 184 may completely surround hole 84. However, intersection point 188-3 may offer additional isolation of circuitry 180 and metal structures 182. If external contaminants entered the area containing metal structures 182-1 and circuitry 180-1, intersection point 188-3 may prevent the contaminants from reaching circuitry 180-2 and metal structures 182-2.

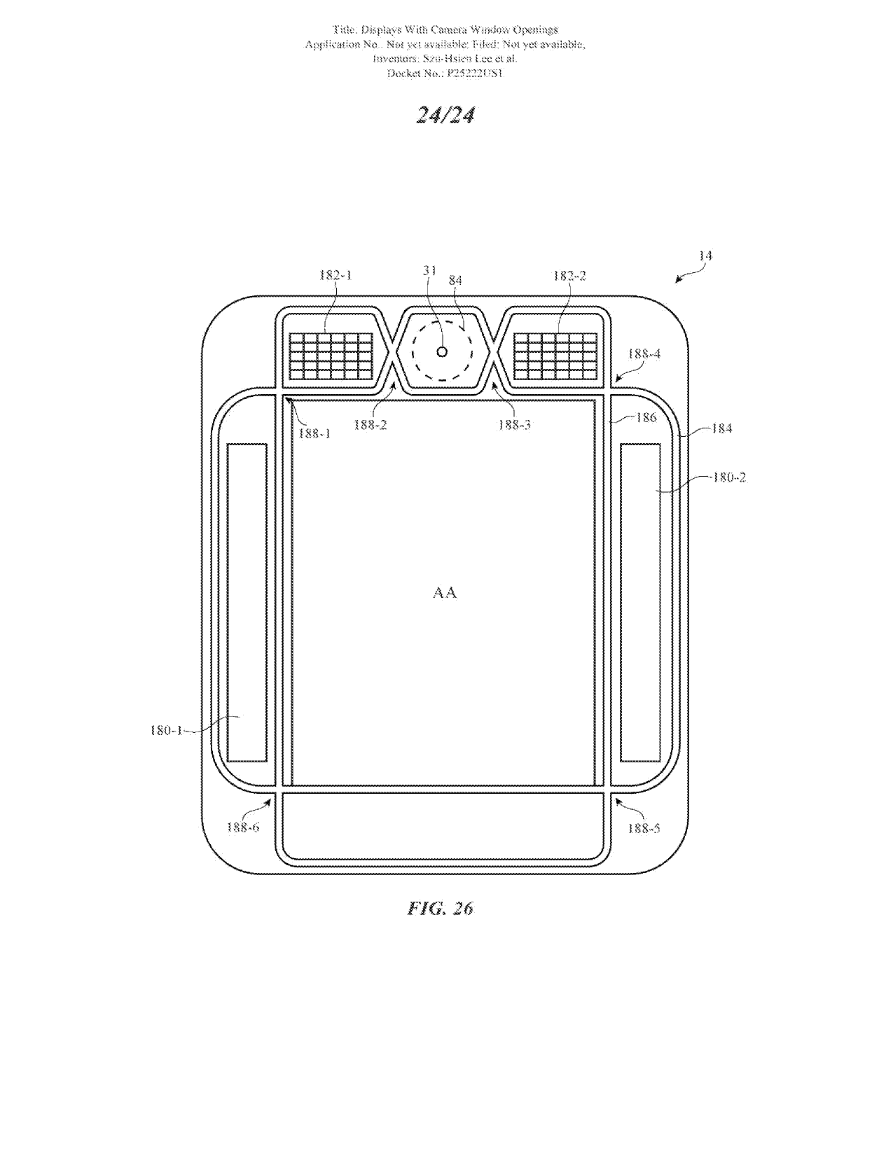

FIG. 26 shows an illustrative arrangement of sealant lines 184 and 186 in which sealant lines 184 and 186 have six intersection points. The additional crossover points ensure that metal structure 182-1, metal structure 182-2, circuitry 180-1, and circuitry 180-2 are each isolated by sealant lines 184 and 186.

The sealant depicted in FIGS. 18-26 may be dispensed using any desired technique. A sealant application tool may be used to dispense the sealant. The sealant application tool may, for example, use a robotically or manually controlled sealant dispensing valve such as a slit valve or other valve to dispense sealant on the surface of an electronic device structure (e.g. layer 56 or layer 58). Sealant may also be dispensed on the surface of an electronic device structure using spraying, screen printing, pad printing, or other liquid adhesive application techniques. The sealant material may be heated to reduce its viscosity before, during or after application. After the sealant is applied, the sealant may be cured by exposure to moisture, visible light, ultraviolet light, heat, radiation, etc. A sealant application tool may be used to apply sealant to a layer such as color filter glass layer 56, thin-film transistor glass layer 58, both layers 56 and 58, or other electronic device structures in the device.

The foregoing is merely illustrative of the principles of this invention and various modifications can be made by those skilled in the art without departing from the scope and spirit of the invention.

What is claimed is:

1. A display with an active area, the display comprising:
a first glass layer having a recess that extends into the first glass layer;
a camera mounted within the recess;
a second glass layer that overlaps the recess and the camera; and
sealant interposed between the first and second glass layers, wherein the sealant comprises first and second portions that each surround the active area of the display, and wherein the first and second portions of sealant intersect each other.

2. The display defined in claim 1, wherein the first glass layer comprises a thin-film transistor layer, and wherein the second glass layer comprises a color filter layer.

3. The display defined in claim 2, wherein the active area forms a central portion of the display, and wherein the display further comprises an inactive area that surrounds a periphery of the active area.

4. The display defined in claim 3, wherein the inactive area has an opaque masking layer with an opening that is aligned with the camera.

5. The display defined in claim 3, further comprising:
circuitry in the inactive area of the display, wherein the circuitry is interposed between the first portion of sealant and the second portion of sealant.

6. The display defined in claim 5, wherein the first and second portions of sealant have two intersection points, and wherein the circuitry is completely surrounded by the sealant.

7. The display defined in claim 6, further comprising:
metal structures in the inactive area of the display, wherein the metal structures are completely surrounded by the sealant.

8. The display defined in claim 1, wherein the recess comprises a notch that extends partly into the first glass layer from an edge of the first glass layer.

9. The display defined in claim 8, wherein the first portion of sealant extends to the edge of the first glass layer.

10. The display defined in claim 1, wherein the recess comprises a hole.

11. The display defined in claim 1, wherein the first glass layer has first and second opposing surfaces, and wherein the recess extends through the first glass layer form the first surface to the second surface.

12. An electronic device with a display, the display comprising:
a color filter layer;
a thin-film transistor layer;
a recess that penetrates into the thin-film transistor layer;
a camera mounted in the recess; and
sealant that surrounds the recess and forms a seal between the color filter layer and the thin-film transistor layer, wherein the sealant has at least two intersection points.

13. The electronic device defined in claim 12, wherein the display comprises an active area surrounded by an inactive area, and wherein the recess is formed in the inactive area of the display.

14. The electronic device defined in claim 13, wherein the active area and the inactive area have respective peripheries, wherein the sealant comprises first and second sealant lines, and wherein the first and second sealant lines are each adjacent to respective portions of the periphery of the active area and the periphery of the inactive area.

15. The electronic device defined in claim 14, wherein the inactive area has first and second opposing sides connected by third and fourth opposing sides, the display further comprising:
circuitry on the first side of the inactive area, wherein the circuitry is interposed between the first and second sealant lines; and
metal structures on the third side of the inactive area, wherein the circuitry is interposed between the first and second sealant lines.

16. The electronic device defined in claim 15, wherein the circuitry is completely surrounded by the sealant, and wherein the metal structures are completely surrounded by the sealant.

17. The electronic device defined in claim 12, further comprising:
liquid crystal material interposed between the color filter layer and the thin-film transistor layer.

18. A method, comprising:
attaching a first display layer to a second display layer with sealant;
cutting the first and second display layers, wherein cutting the first and second display layers comprises cutting first and second portions of the sealant;
forming a notch in the first display layer that extends partly into the first display layer from an edge of the first display layer, wherein the first and second portions of the sealant are adjacent to the edge of the first display layer such that the notch is surrounded by sealant; and
mounting a camera within the notch.

19. The method defined in claim 18, wherein the first display layer comprises a thin-film transistor glass layer and the second display layer comprises a color filter glass layer.

20. The method defined in claim 18, wherein the notch in the first display layer has first and second opposing sides, and wherein forming the notch in the first display layer comprises forming the notch in the first display layer such that the first portion of the sealant is positioned at the first side of the notch and the second portion of the sealant is positioned at the second side of the notch.
